(19) United States
(12) Patent Application Publication
(10) Pub. No.: US 2017/0110867 A1
(43) Pub. Date: Apr. 20, 2017

(54) INTERMEDIATE SPLICED PORTION WATERPROOFING STRUCTURE OF COVERED ELECTRICAL WIRES

(71) Applicant: SUMITOMO WIRING SYSTEMS, LTD., Mie (JP)

(72) Inventor: Keisuke YAGIHASHI, Mie (JP)

(73) Assignee: SUMITOMO WIRING SYSTEMS, LTD., Mie (JP)

(21) Appl. No.: 15/282,043

(22) Filed: Sep. 30, 2016

(30) Foreign Application Priority Data
Oct. 20, 2015 (JP) 2015-206605

(51) Int. Cl. H02G 15/18; H01B 7/282

(52) U.S. Cl. CPC H02G 15/18; H01B 7/2825

(57) ABSTRACT

An intermediate spliced portion waterproofing structure has a first covered electrical wire where an intermediate portion of an insulation sheath is stripped off to expose a lead wire; a second covered electrical wire where an end portion or an intermediate portion of an insulation sheath is stripped off to expose a lead wire, and where a lead wire-exposed portion thereof is electrically connected to a lead wire-exposed portion of the first covered electrical wire; a protective sheet made of a hook-and-loop fastener wrapping an intermediate spliced portion in a state where the intermediate spliced portion is positioned inside a raised fiber-forming surface, the intermediate spliced portion being a connecting portion of the lead wire-exposed portions of the first and second covered electrical wires, and a waterblocking material made of a moisture-curable waterblocking agent that is applied to the protective sheet so as to surround the intermediate spliced portion.

### CROSS-REFERENCE TO RELATED APPLICATIONS

The present application claims priority under 35 U.S.C. §119 of Japanese Application No. 2015-206605, filed on Oct. 20, 2015, the disclosure of which is expressly incorporated by reference herein in its entirety.

### BACKGROUND OF THE INVENTION

1. Field of the Invention

The present invention relates to a waterproofing structure of an intermediate spliced portion of covered electrical wires.

2. Description of Related Art

An intermediate spliced portion of covered electrical wires is an electrical connecting portion of an intermediate portion of a covered electrical wire where an insulation sheath is stripped off to expose a lead wire, and an intermediate portion or end portion of another covered electrical wire where the insulation sheath is stripped off to expose the lead wire. Traditionally, various waterproofing measures have been applied to the lead wire-exposed portion and the end portion of the insulation sheath of the intermediate spliced portion (see, for example, Japanese Patent Laid-Open Publication No. 2012-80633, FIGS. 1-7, Paragraphs [0008] and [0012]).

As illustrated in FIG. 7, in Japanese Patent Laid-Open Publication No. 2012-80633, a waterproofed intermediate spliced portion of an electrical wire 122 is disclosed. The waterproofed intermediate spliced portion is manufactured by supplying a waterblocking agent 140 to an intermediate spliced portion 120 of the electrical wire 122, then covering the waterblocking agent 140 supplied to the intermediate spliced portion 120 with a protective sheet 130, then curing the waterblocking agent 140 in a state where, by causing the protective sheet 130 to deform along with a deformation of a surface of the waterblocking agent 140, the surface of the waterblocking agent 140 and the protective sheet 130 are kept in an adhered state. Japanese Patent Laid-Open Publication No. 2012-80633 also discloses that a moisture-curable and light-curable resin is used as the waterblocking agent 140.

However, with respect to the technology disclosed in Japanese Patent Laid-Open Publication No. 2012-80633, in addition to the waterblocking agent not curing in places where light does not reach, since the surface of the waterblocking agent and the protective sheet are in the adhered state, there are cases in which moisture contained in the air is not sufficiently supplied to the waterblocking agent, causing the waterblocking agent to remain in a sol-gel state without curing. Thus, a waterproofing performance of the intermediate spliced portion is not sufficiently ensured.

### SUMMARY OF THE INVENTION

The present invention provides an intermediate spliced portion waterproofing structure of covered electrical wires in which a waterproofing performance of the intermediate spliced portion can be increased.

In order to achieve the above-noted objective, the intermediate spliced portion waterproofing structure of covered electrical wires according to the present invention has a first covered electrical wire where an intermediate portion of an insulation sheath is stripped off to expose a lead wire; a second covered electrical wire where an end portion or an intermediate portion of an insulation sheath is stripped off to expose a lead wire and where a lead wire-exposed portion thereof is electrically connected to a lead wire-exposed portion of the first covered electrical wire; a protective sheet made of a hook-and-loop fastener wrapping an intermediate spliced portion in a state where the intermediate spliced portion is positioned inside a raised fiber-forming surface, the intermediate spliced portion being a connecting portion of the lead wire-exposed portions of the first covered electrical wire and the second covered electrical wire; and a waterblocking material made of a moisture-curable waterblocking agent that is applied to the protective sheet so as to surround the intermediate spliced portion, and is then cured by absorbing moisture.

According to this configuration, in the intermediate spliced portion waterproofing structure of covered electrical wires according to the present invention, the protective sheet made of the hook-and-loop fastener wraps the intermediate spliced portion in a state where the intermediate spliced portion is positioned inside the raised fiber-forming surface. As a result, the moisture-curable waterblocking agent, applied to the protective sheet so as to surround the intermediate spliced portion, is not sealed by the protective sheet, and the moisture-containing air flowing from an end portion of the protective sheet and through gaps between the raised fibers reaches the waterblocking agent penetrating an interior of the insulation sheaths from the exposed lead wires portion, thereby enabling a sufficient supply of moisture to the waterblocking agent. As a result, the moisture-curable waterblocking agent does not remain in an uncured state and it can be ensured that the waterblocking agent absorbs moisture and cures, thereby enhancing waterproofing performance.

Additionally, in the intermediate spliced portion waterproofing structure of covered electrical wires according to the present invention, the raised fiber-forming surface of the protective sheet is the hook-and-loop fastener in which male-shaped raised fibers and female-shaped raised fibers are intermingled thereon.

According to this configuration, in the intermediate spliced portion waterproofing structure of covered electrical wires according to the present invention, by engaging the male-shaped raised fibers and the female-shaped raised fibers of the mutually opposed fiber-forming surfaces in a state where the protective sheet, made of the hook-and-loop fastener, wraps the intermediate spliced portion in a state where the intermediate spliced portion is positioned inside the raised fiber-forming surface, the state in which the protective sheet wraps the intermediate spliced portion can be held without using adhesive tape or adhesive agents.

According to the present invention, it is possible to provide the intermediate spliced portion waterproofing structure of covered electrical wires in which waterproofing performance of the intermediate spliced portion can be increased.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of covered electrical wires having an intermediate spliced portion according to a first embodiment of the present invention;

FIGS. 2A and 2B illustrate a manufacturing method of an intermediate spliced portion waterproofing structure of covered electrical wires according to the first embodiment; FIG. 2A is a plan view of a state where the intermediate spliced portion is disposed on top of a protective sheet and FIG. 2B is a view of a right end surface thereof;

FIGS. 3A and 3B illustrate the manufacturing method of the intermediate spliced portion waterproofing structure of covered electrical wires according to the first embodiment; FIG. 3A is a plan view of a state where a waterblocking agent is supplied to the intermediate spliced portion and FIG. 3B is a view of a right end surface thereof;

FIGS. 4A and 4B illustrate the manufacturing method of the intermediate spliced portion waterproofing structure of covered electrical wires according to the first embodiment; FIG. 4A is a plan view of a state where the intermediate spliced portion is wrapped with the protective sheet and FIG. 4B is a view of a right end surface thereof

FIGS. 5A and 5B are explanatory diagrams of an operation of the intermediate spliced portion waterproofing structure of covered electrical wires according to the first embodiment; FIG. 5A is an explanatory plan view and FIG. 5B is an explanatory diagram of a right end surface thereof;

FIGS. 6A, 6B, 6C, and 6D are lateral views of the protective sheet according to the first embodiment; and

FIG. 7 is a perspective view of a waterproofed intermediate spliced portion of an electrical wire disclosed in Japanese Patent Laid-Open Publication No. 2012-80633.

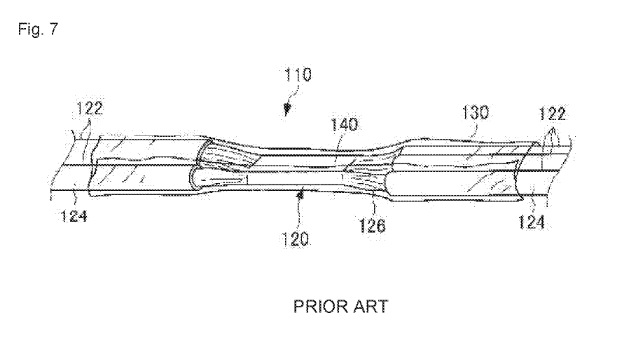

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

In the following, an embodiment of an intermediate spliced portion waterproofing structure of covered electrical wires according to the present invention is described with reference to the drawings.

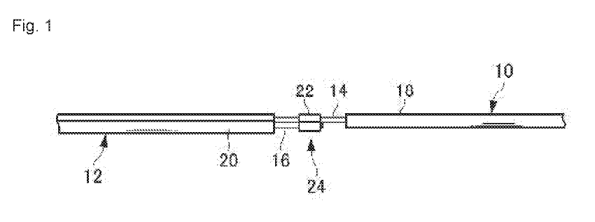

First, a configuration of the present embodiment is described with reference to FIG. 1 through FIGS. 4A and 4B. An intermediate spliced portion waterproofing structure 1 has a first covered electrical wire 10 where an intermediate portion of an insulation sheath 18 is stripped off to expose a lead wire 14; a second covered electrical wire 12 where an end portion or an intermediate portion of an insulation sheath 20 is stripped off to expose a lead wire 16 and where a lead wire-exposed portion thereof is electrically connected to a lead wire-exposed portion of the first covered electrical wire 10; a protective sheet 26 made of hook-and-loop fasteners 34 and 36 wrapping an intermediate spliced portion 24 in a state where the intermediate spliced portion 24 is positioned inside a raised fiber-forming surface 30, the intermediate spliced portion 24 being a connecting portion of the lead wire-exposed portions of the first covered electrical wire 10 and the second covered electrical wire 12; and a waterblocking material 44 made of a moisture-curable waterblocking agent 42 that is applied to the protective sheet 26 so as to surround the intermediate spliced portion 24, and is then cured by absorbing moisture.

The first and second covered electrical wires 10 and 12 have lead wires 14 and 16, respectively, which are each a bundle of copper wires having a small diameter, and insulation sheaths 18 and 20, which are each made of polyvinyl chloride (PVC) material and the like, covering the lead wires 14 and 16. The lead wires 14 and 16 can each be one copper wire or the like having a large diameter. Further, the lead wires 14 and 16 can each be aluminum wires.

As illustrated in FIG. 1, in the first covered electrical wire 10, the insulation sheath 18 is stripped off at the intermediate portion thereof, thereby exposing the lead wire 14. As illustrated in FIG. 1, in the second covered electrical wire 12, the insulation sheath 20 is stripped at the end portion thereof, thereby exposing the lead wire 16. However, the second covered electrical wire 12 is not limited to the foregoing, and the insulation sheath 20 can be stripped off at the intermediate portion thereof to expose the lead wire 16. The intermediate spliced portion 24 is the connecting portion where the lead wire 14 exposed at the intermediate portion of the first covered electrical wire 10 and the exposed lead wire 16 of the second covered electrical wire 12 are electrically connected.

Further, while the intermediate spliced portion 24 is configured by the two covered electrical wires 10 and 12 in FIG. 1, it is not limited thereto and can be configured by three or more covered electrical wires. Connecting the exposed lead wires 14 and 16 can be performed by resistance welding, ultrasonic welding, laser welding, or the like, or by crimping an intermediate crimp terminal or the like. In FIG. 1, the exposed lead wires 14 and 16 are connected via a connecting member 22, such as the intermediate crimp terminal.

The protective sheet 26 is a sheet having a rectangular or an oblong rectangular shape, and a length thereof in a longitudinal direction is longer by a required length than a length of the exposed lead wire 14 of the first covered electrical wire 10 of the intermediate spliced portion 24, so as to be capable of covering an area including an end portion of the stripped-off insulation sheath 18, and a length thereof in a width-direction perpendicular to the longitudinal direction is a length that allows the protective sheet 26 to completely wrap at least the intermediate spliced portion 24. However, the shape of the protective sheet 26 is not limited thereto and can be an arbitrary shape, such as a trapezoidal shape, a polygonal shape, or a circular shape.

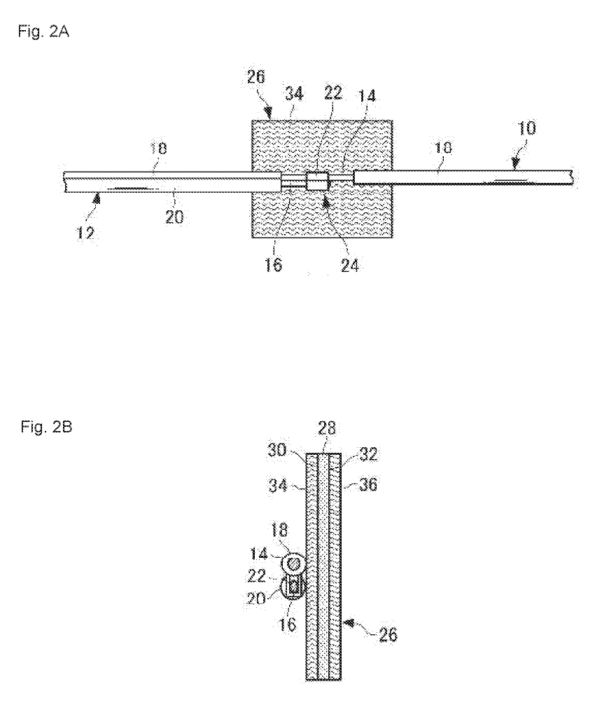

The protective sheet 26 is made of single-sided or double-sided hook-and-loop fasteners 34 and 36, in which raised fibers are densely and integrally formed on an entire one side or both sides of a sheet substrate 28 made of a synthetic resin such as, for example, polyvinyl chloride (PVC), polypropylene (PP) or polyamide (PA). A surface on which the raised fibers are formed is referred to the raised fiber-forming surface 30. As illustrated in FIGS. 2A and 2B through FIGS. 4A and 4B, in the present embodiment, the double-sided hook-and-loop fasteners 34 and 36, in which the raised fibers are formed on both sides of the sheet substrate 28, are used.

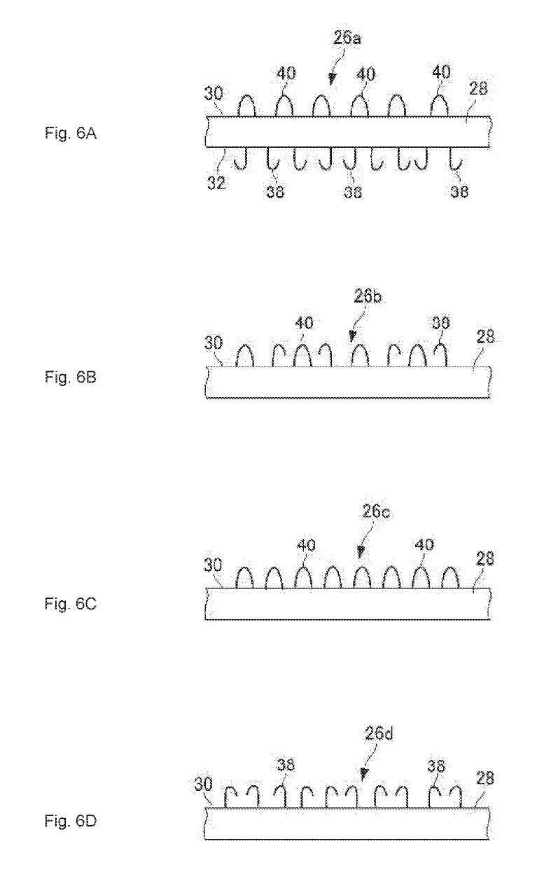

Specifically, as illustrated in FIG. 6A, on the protective sheet 26 according to the present embodiment, female-shaped raised fibers 40 are formed on one side (the raised fiber-forming surface 30) of the sheet substrate 28, and male-shaped raised fibers 38 are formed on another side (a raised fiber-forming surface 32). When a protective sheet 26a, made of the foregoing double-sided hook-and-loop fasteners, is wound in a sushi roll-shape, a male-shaped hook-and loop fastener and a female-shaped hook-and-loop fastener are mutually opposed and overlap each other, whereby the male-shaped raised fibers 38 and the female-shaped raised fibers 40 engage with each other and the protective sheet 26a can be fixated in a wound state.

Here, the male-shaped raised fibers 38 have, for example, a letter J-shape in which a front end portion is curved, or a hook portion in which an annular protruding portion is formed on a front end portion of a rod-shaped portion (a so-called mushroom-shape, or the like). The female-shaped raised fibers 40 have, for example, a loop portion that is attachably/removably engageable with the hook portion of the male-shaped raised fibers 38.

The hook-and-loop fastener of the protective sheet 26 is not limited to the double-sided hook-and-loop fastener; as illustrated in FIG. 6B, a protective sheet 26b can be a hook-and-loop fastener in which the male-shaped raised fibers 38 and the female-shaped raised fibers 40 are intermingled on the raised fiber-forming surface 30 thereof. In this case, in a state where the protective sheet 26b is two-folded so that the raised fiber-forming surface 30 faces inward, the protective sheet 26b can be fixated in a two-folded state by engaging the male-shaped raised fibers 38 and the female-shaped raised fibers 40.

Further, as illustrated in FIG. 6C, a one-sided female-shaped hook-and-loop fastener in which the female-shaped raised fibers 40 are formed on only one side can be used as a protective sheet 26c, or, as illustrated in FIG. 6D, a one-sided male-shaped hook-and-loop fastener in which the male-shaped raised fibers 38 are formed on only one side can be used as a protective sheet 26d.

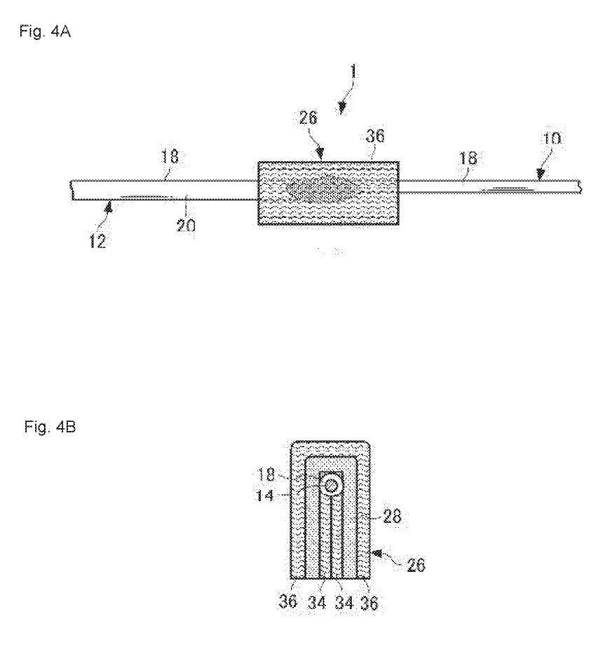

The protective sheet 26 wraps the intermediate spliced portion 24 in a state where the intermediate spliced portion 24 is positioned inside the raised fiber-forming surface 30. In the present embodiment, as illustrated in FIG. 4B, by two-folding the protective sheet 26 so that the raised fiber-forming surface 30 faces inward, and sandwiching the intermediate spliced portion 24 therebetween, the intermediate spliced portion 24 is wrapped with the protective sheet 26. From the two-folded state, the protective sheet 26 can be further wound, in the sushi roll-shape, onto the intermediate spliced portion 24. In other words, any type of wrapping method can be used as long as the intermediate spliced portion 24 is wrapped so as to be positioned inside the raised fiber-forming surface 30.

In addition, in a state where the intermediate spliced portion 24 is wrapped with the protective sheet 26, the protective sheet 26 can be fixated on both end portions thereof by an arbitrary fixating method, such as winding an adhesive tape, or an adhesive agent.

Further, in a case where one side of the protective sheet 26 is the male-shaped hook-and-loop fastener and another side is the female-shaped hook-and-loop fastener, when the protective sheet 26 is two-folded so that the raised fiber-forming surface 30 on one side faces inward, both end portions can be matched incompletely so as to be displaced from each other by a predetermined length. From this state, the protective sheet 26 can be further wound in the sushi roll-shape, and by matching the displaced portion of the hook-and-loop fastener and the wound hook-and-loop fastener, an adhesive force thereof can fixate the protective sheet 26.

The waterblocking material 44 is made of a moisture-curable waterblocking agent 42 that is applied to the protective sheet 26 so as to surround the intermediate spliced portion 24, and is then cured by absorbing moisture. The waterblocking agent 42, in a liquid form before curing and having a viscosity of some degree, is supplied to the intermediate spliced portion 24 so as to spread over the stripped and exposed lead wires 14 and 16 and the end portions of the stripped insulation sheaths 18 and 20, and the like. The waterblocking material 44 is the waterblocking agent 42 having been cured by absorbing moisture.

Various types of moisture-curable resin that can be applied in a flowing, viscous liquid form and that can be cured in such state, as described above, can be used as the waterblocking agent 42. The waterblocking agent 42 is a moisture-curable synthetic resin such as, for example, silicone resin, acrylic resin, urethane resin, polyamide resin, or epoxy resin. A moisture-curable synthetic resin that cures at a humidity level of 65% or higher, for example, can be used as the waterblocking agent 42.

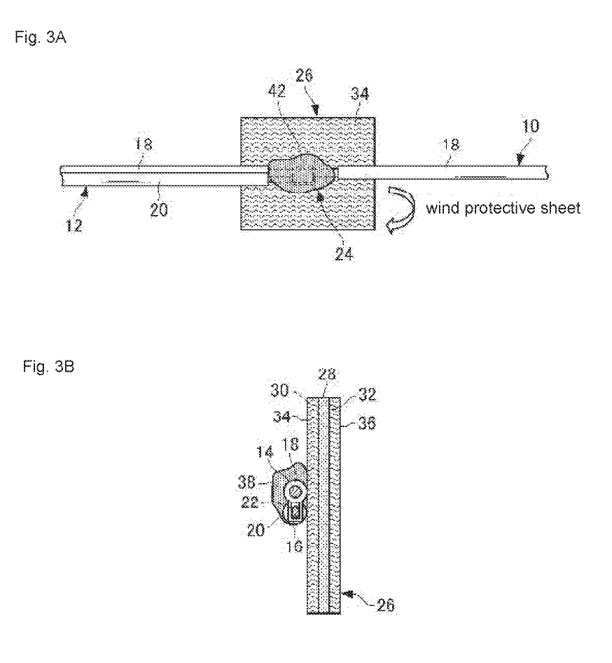

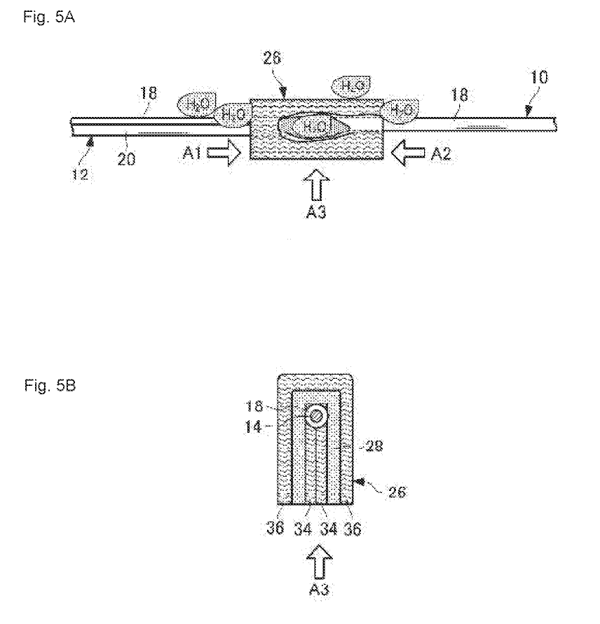

Next, a manufacturing method of the intermediate spliced portion waterproofing structure 1 according to the present embodiment is described. First, the covered electrical wires 10 and 12 having the intermediate spliced portion 24 are prepared (FIG. 1), and the intermediate spliced portion 24 is placed on a substantially center portion of the raised fiber-forming surface 30 of the protective sheet 26 (FIGS. 2A and 2B). Next, a required amount of the waterblocking agent 42 in the liquid form is supplied to the intermediate spliced portion 24 (FIGS. 3A and 3B); the protective sheet 26 is wound onto the intermediate spliced portion 24 so as to wrap it in a state where it is positioned inside the raised fiber-forming surface 30 (FIGS. 4A and 4B); and in this state, the protective sheet 26 is partially fixated at both end portions thereof by winding adhesive tape or the like. Thereafter, moisture contained in air supplied from a lateral end portion of the protective sheet 26 is absorbed by the waterblocking agent 42, causing it to cure and become the waterblocking material 44, thereby completing the manufacture of the intermediate spliced portion waterproofing structure 1 of the covered electrical wires (FIGS. 5A and 5B).

Next, the operation and effects of the present invention are described. As illustrated in FIGS. 4A and 4B, in the intermediate spliced portion waterproofing structure 1 of covered electrical wires according to the present embodiment, the protective sheet 26, made of the hook-and-loop fasteners 34 and 36, wraps the intermediate spliced portion 24 so that it is positioned inside the raised fiber-forming surface 30. In this configuration, the moisture-curable waterblocking agent 42, applied to the protective sheet 26 so as to surround the intermediate spliced portion 24, is not sealed by the protective sheet 26, and the moisture-containing air flowing from the end portion of the protective sheet 26 and through gaps between the raised fibers reaches the waterblocking agent 42 that penetrates an interior of the insulation sheaths 18 and 20 from the exposed lead wires portion, thereby enabling a sufficient supply of moisture to the waterblocking agent 42. Specifically, as illustrated in FIGS. 5A and 5B, the moisture-containing air can be supplied to the waterblocking agent 42 from directions indicated by arrows A1, A2, and A3. As a result, the moisture-curable waterblocking agent 42 does not remain in an uncured state and it can be ensured that the waterblocking agent 42 absorbs moisture and cures, thereby enhancing waterproofing performance.

Additionally, in the intermediate spliced portion waterproofing structure 1 according to the present embodiment, the raised fiber-forming surface 30 of the protective sheet 26 is the hook-and-loop fastener in which the male-shaped raised fibers 38 and the female-shaped raised fibers 40 are intermingled thereon. According to this configuration, by engaging the male-shaped raised fibers 38 and the female-shaped raised fibers 40 of the mutually opposed fiber-forming surfaces 30 and 30 in a state where the protective sheet 26, made of the hook-and-loop fastener, wraps the intermediate spliced portion 24 in a state where the intermediate spliced portion 24 is positioned inside the raised fiber-forming surface 30, the state in which the protective sheet 26 wraps the intermediate spliced portion 24 can be held without using the adhesive tape or adhesive agent.

The intermediate spliced portion waterproofing structure of covered electrical wires according to the present invention has an effect of increasing the waterproofing performance of the intermediate spliced portion, and is generally useful for intermediate spliced portion waterproofing structures of covered electrical wires that configure wire harnesses.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An intermediate spliced portion waterproofing structure of covered electrical wires, comprising:
a first covered electrical wire having an intermediate portion of an insulation sheath stripped off to expose a lead wire;
a second covered electrical wire having an end portion or an intermediate portion of an insulation sheath stripped off to expose a lead wire, wherein a lead wire-exposed portion of the second covered electrical wire is electrically connected to a lead wire-exposed portion of the first covered electrical wire;
a protective sheet made of a hook-and-loop fastener wrapping an intermediate spliced portion in a condition in which the intermediate spliced portion is positioned inside a raised fiber-forming surface, the intermediate spliced portion being a connecting portion of the lead wire-exposed portions of the first covered electrical wire and the second covered electrical wire; and
a waterblocking material made of a moisture-curable waterblocking agent that is applied to the protective sheet so as to surround the intermediate spliced portion, and is then cured by absorbing moisture.

2. The intermediate spliced portion waterproofing structure of covered electrical wires according to claim 1, wherein the raised fiber-forming surface of the protective sheet is the hook-and-loop fastener having male-shaped raised fibers and female-shaped raised fibers intermingled thereon.
